(19) United States
(12) Patent Application Publication
(10) Pub. No.: US 2018/0252985 A1
(43) Pub. Date: Sep. 6, 2018

(54) Method and apparatus for frequency comb generation using an optical manipulator

(71) Applicant: University of Helsinki, University of Helsinki (FI)

(72) Inventors: Markku Vainio, Helsinki (FI); Ville Ulvila, Vantaa (FI); Lauri Halonen, Helsinki (FI); Christopher Phillips, Zürich (CH); Jari Peltola, Helsinki (FI)

(73) Assignee: University of Helsinki, University of Helsinki (FI)

(21) Appl. No.: 15/759,291

(22) PCT Filed: Sep. 12, 2016
(86) PCT No.: PCT/FI2016/050627

§ 371 Date: Mar. 12, 2018

(30) Foreign Application Priority Data
Sep. 11, 2015 (FI) 20155655

(51) Int. Cl. G02F 1/377; G02F 1/35; G02F 1/355

(52) U.S. Cl. CPC G02F 1/3775; G02F 1/3536; G02F 1/3544; G02F 2001/3542; G02F 2001/3548; G02F 2203/56; G02F 1/3558

(57) ABSTRACT

An apparatus for frequency comb generation comprises a component of second order nonlinearity, where the component is configured to interact with a laser beam or derivatives of the laser beam and thereby generate frequencies for the frequency comb. The apparatus comprises advantageously an optical manipulator, which both comprises the component but additionally is configured to introduce the beam or its derivatives in a repetitive or resonating manner to the component. The component is e.g. a monolithic or other solid optical resonator or microresonator comprising optical crystal and having said second order nonlinearity.

### PRIORITY

This application is a U.S national application of PCT-application PCT/FI2016/050627 filed on Sep. 12, 2016 and claiming priority of Finnish application FI 20155655 filed on Sep. 11, 2015, the contents of all of which are incorporated herein by reference.

### TECHNICAL FIELD OF THE INVENTION

The invention relates to a method and an apparatus for generating a frequency comb. Especially the invention relates to a generation of an optical frequency comb using a laser beam introduced to an optical manipulator.

### BACKGROUND OF THE INVENTION

An optical frequency comb (OFC), that is, coherent broadband light that has a spectrum consisting of many equidistant discrete lines, has become a valuable tool in many research areas, such as time and frequency metrology and molecular spectroscopy. Mode-locking of lasers is the most common method used to generate OFC. Other methods include phase-modulated Fabry-Perot cavities, and optical microresonators. Octave spanning frequency comb generation and mode-locking have recently been demonstrated with such microresonators.

The mode-locked laser example produces in time domain short (femtosecond) laser pulses with a certain repetition frequency fᵣₑₚ. The spectrum of the laser is a frequency comb, where the mode spacing is exactly fᵣₑₚ, as can be seen in prior art FIG. 1.

In the time domain of the left portion of FIG. 1, an OFC generator based on a mode-locked laser produces a train of short laser pulses at repetition rate fᵣₑₚ, which is of the order of 100 MHz. The corresponding frequency-domain presentation of the OFC light, i.e., the spectrum, is obtained by Fourier transform. The spectrum consists of a wide comb of narrow laser peaks, or modes, as is exemplified in the right portion of FIG. 1. The spacing between the peaks is exactly fᵣₑₚ and the spectral bandwidth of the comb is up to 100 THz. Therefore, a typical number of the peaks can be up to one million (BW/fᵣₑₚ˜10¹⁴ Hz/10⁸ Hz).

The microresonator comb is also referred to as Kerr comb, as the comb formation is based on an optical Kerr effect, i.e., third order optical nonlinearity. (Third order nonlinearity=cubic nonlinearity=Kerr nonlinearity=χ⁽³⁾ nonlinearity). One example of the microresonator comb is described in a publication of EP1988425B1.

The principle of Kerr comb formation in a microresonator is presented in a prior art FIG. 2, where the third order (Kerr) nonlinearity of the resonator material leads to frequency comb formation. A continuous-wave (CW) laser light is coupled into a microresonator using, for example, an optical fiber or prism. The spectrum of this pump laser consists of a single peak—in other words, the laser emits at only one wavelength at a time. The microresonator is designed such that the laser field resonates in it, which leads to significant optical power enhancement in the resonator. A fraction of the resonant light is coupled out e.g. using a fiber and directed to an application. The comb formation process starts by degenerate four-wave mixing (FWM), where two pump photons (101a, 101b) are converted to a pair of new photons (102a, 102b). Energy is conserved so: 2hνₚᵤₘₚ=hν₁₀₂ₐ+hν_{102b}, where h is the Planck constant and νₚᵤₘₚ is the pump laser frequency (hνₚᵤₘₚ=c/λₚᵤₘₚ, where c is the speed of light and λₚᵤₘₚ is the pump laser wavelength). hν₁₀₂ₐ and hν_{102b} are the frequencies of the new fields. The side bands are generated symmetrically around the pump frequency νₚᵤₘₚ.

The four-wave mixing is one of the many effects that originate from Kerr nonlinearity. The comb formation process typically starts by so-called degenerate FWM, where two pump laser photons are converted to a pair of new photons. This leads to a symmetric sideband generation around the initial pump laser frequency (Process (1) in prior art FIG. 2). Once the side bands are generated, the comb formation process can also continue by non-degenerate FWM, where mixing of two modes of the comb produce additional modes (Process (2) in prior art FIG. 2).

The strength of the Kerr nonlinearity (and hence the strength of the FWM process) is proportional to I_{L}×n₂, where I_{L} is the laser intensity in the resonator (units W/m²), and n₂ is the so-called nonlinear refractive index (a.k.a. Kerr coefficient; units m²/W). (The “total” refractive index is n=n₀+I_{L}×n₂, where no is the linear refractive index of the material). An OFC can be generated only if I_{L}×n₂ is high enough. Just like no, the nonlinear refractive index is a material property and cannot be varied. The value of n₂ is relatively small for most materials, which means that I_{L} needs to be very high in order to obtain OFC generation. High enough intensity can be obtained in a high-quality microresonator, which confines the laser field in a very small mode volume.

The non-degenerate FWM can be understood qualitatively as follows: As two laser beams at frequencies ν₁ and ν₂ propagate in the material, they produce, through the Kerr effect, a nonlinear refractive index, which oscillates at difference frequency Δν=|ν₁−ν₂|. This oscillating refractive index modulates the phases of the laser fields, leading to new sidebands at frequencies ν₁±Δν and ν₂±Δν.

The mode spacing of the comb is (roughly) determined by the resonator size.

The frequency difference between the adjacent resonance modes of the microresonator is Δν=c/nL, where c is the speed of light, and n˜n₀ is the refractive index of the resonator material. L is the round-trip length of the resonator. For a silica microresonator, a typical optical circumference is nL=1.5×1 mm, leading to a microresonator mode spacing of Δν˜(3×10⁸ m/s)/1.5 mm˜200 GHz. The mode spacing of the frequency comb is approximately the same as the mode spacing of the microresonator.

Dispersion, the variation of refractive index no with wavelength, has an effect on comb formation. Due to the dispersion, the frequency spacing Δν of the microresonator modes is not precisely constant but changes with wavelength. This can potentially lead to a non-equidistant OFC, and will ultimately limit the optical bandwidth of the comb because the comb modes generated by FWM do not anymore overlap with the resonator modes. However, self-phase modulation (SPM) and cross-phase modulation (XPM), which are effects originating from Kerr nonlinearity, can partly compensate for the microresonator dispersion. As a result, generation of an equidistant broadband OFC is possible. Note that as Kerr nonlinearity (n₂) is a material property, the dispersion compensation (and hence efficient Kerr comb generation) is only possible at certain wavelengths, depending on the microresonator material used in the experiments.

In the self-phase modulation the phase of a light wave is modified by the wave itself. This originates from the Kerr effect: The refractive index of the material changes by Δn=I_{L}×n₂, where I_{L} is again the intensity of the light field. The change in the refractive index leads to a phase change, as the wavelength in the material is λ₀/n=λ₀/(n₀+Δn), with λ₀ being the vacuum wavelength.

Cross-phase modulation (XPM) is essentially the same as SPM, but now the phase of light wave A is modified by the intensity of light wave B (and vice versa). Again, this occurs due to Kerr nonlinearity, which is described by the nonlinear refractive index n₂.

There are however some disadvantages relating to the known prior art, such as that the Kerr comb generation is generally only possible in the microresonators, whereupon the mode spacing is quite large, which is clear drawback, because especially in gas analysis small mode spacing is needed. In addition, laser intensity required for OFC generation is very high in most materials used for Kerr comb generation. Furthermore the comb mode spacing according to the Kerr com generation cannot be tailored or changed. In addition the Kerr comb generation, as well as OFC generation by mode-locked lasers, is also very difficult or even impossible in mid-infrared wavelengths.

### SUMMARY OF THE INVENTION

An object of the invention is to alleviate and eliminate the problems relating to the known prior art. Especially the object of the invention is to provide an apparatus and method for frequency comb generation by laser intensity significantly smaller than in known systems. In addition, one object of the invention is to provide a method and apparatus, where nonlinearity can be tailored and the comb mode spacing can be changed or controlled. Also an object is to providing the optical frequency comb generation with significantly smaller laser intensities than in prior art, as well as to generate mid-infrared wavelengths.

The object of the invention can be achieved by the features of independent claims.

The invention relates to an apparatus for frequency comb generation using an optical manipulator according to claim 1. In addition the invention relates to a method for frequency comb generation using an optical manipulator according to claim 22.

According to an embodiment of the invention a frequency comb is generated by using an optical manipulator and a component comprising second order nonlinearities. The optical manipulator is advantageously configured to introduce a laser beam and/or its derivatives in a repetitive (e.g. resonating) manner to the component. The component is configured to interact with said laser beam and/or derivatives of said laser beam and thereby generate frequencies for the frequency comb. The component comprises advantageously optical nonlinear crystal material having second order nonlinearity. The component material may be for example quasi-phase-matched or birefringent phase matched optical nonlinear crystal material. The derivatives of said laser beam are e.g. beams at harmonic frequencies (such as second harmonic frequency) of said laser beam or frequencies of the already generated comb which are reintroduced to the component.

In the invention the third order nonlinearity (Kerr effect) is mimicked by a process called cascaded second order nonlinearity, which is also known as a cascaded quadratic nonlinearity (CQN) or cascaded χ⁽²⁾ nonlinearity or χ⁽²⁾:χ⁽²⁾-nonlinearity. The second order nonlinear effects occurs in materials that lack inversion symmetry—materials that possess large second order nonlinearity are often referred to as nonlinear crystals.

According to an embodiment the component is configured to apply cascading quadratic nonlinearity process, to which said frequency comb generation is based on. According to an embodiment, the component may have, or is arranged to apply, a phase matching deviated slightly from zero (Δk≠0) in order to perform said frequency comb generation by cascaded quadratic nonlinearity. However, according to an exemplary embodiment the second order nonlinearities at phase matching (Δk=0) may also be enough to provide the frequency comb generation. The invention using the component with the second order nonlinear effects offers huge advantage over the known prior art, such as Kerr nonlinearity, namely the effective third order nonlinearity arising from the cascaded quadratic nonlinearity can be tailored by adjusting Δk, while the prior art “true” Kerr nonlinearity is a fixed material parameter.

The component comprises advantageously quasi-phase-matched optical nonlinear crystal material, such as periodically poled lithium niobate (PPLN), periodically poled lithium tantalite (PPLT), periodically poled potassium titanyl phosphate (PPKTP), lithium niobate doped with metal ions, such as Mg (MgO:PPLN). Alternatively, or in addition to, the component may also comprise birefringently phase-matched nonlinear crystals, such as beta barium borate (BBO), which are suitable for applying cascading quadratic nonlinearity process.

Advantageously the apparatus is configured to produce the frequency comb in the mid-infrared region. This can be achieved directly by using a mid-infrared pump laser for the cascaded quadratic nonlinear effect, or indirectly by using an additional nonlinear crystal material with second order nonlinearity to transfer a comb from e.g. near-infrared to mid-infrared, as is described in this document elsewhere (e.g. FIGS. 5A, 5B).

According to an embodiment the optical manipulator may comprise an optical resonator, optical fiber resonator or loop, or microresonator or monolithic or other solid crystal resonator.

According to an embodiment the component is arranged to function as an optical waveguide. In the embodiment the optical manipulator may comprise mirrors, which are arranged around the component, whereupon the mirrors are configured to reflect laser beam and/or its derivatives in a repetitive manner to the component. According to an example the ends of the component are provided with reflective material, such as mirrors, in order to reflect said laser beam wavelength and/or its derivatives in a repetitive manner within said component functioning as a waveguide.

In addition, according to an embodiment, interface materials at the interface of the component and/or the surrounding medium may be selected so to perform a total internal reflection of the laser beam and/or its derivatives and thereby generating the resonator. Still in addition an angle of incidence of the laser beam and/or its derivatives in relation to the inner surface of the component (so inside the component) may be arranged to be as a critical angle for the total internal reflection so that said total internal reflection happens and thus reintroducing the laser beam and/or its derivatives in a repetitive or resonating manner back to the component.

The repetitive manner means that the laser beam and/or its derivatives constructively interferes with itself, beam and/or its derivatives within said component (or optical manipulator) after a round trip thereby generating a resonator of said component.

According to an embodiment the optical manipulator may comprise an optical microresonator, wherein the component material is arranged to interact with the laser beam and/or derivatives of the laser beam and thereby generate frequencies for the frequency comb. The microresonator may be fabricated for example of a second-order nonlinear quasi-phase-matched or birefringent optical crystal, as is discussed elsewhere in this document.

According to an embodiment the optical manipulator comprises at least one first loop, such as an optical fiber resonator loop. The loop may receive the laser beam and/or its derivatives and additionally introduce the received laser beam and/or its derivatives back to the optical manipulator and to said component, thereby forming the resonator. It should be noted that according to an embodiment at least two first loops may be used. When the length of the second first loop is different than the length of the first first loop, an additional comb with a different mode spacing is generated.

Because the mode spacing of the comb is (roughly) determined by the resonator size, the length of the resonator (such as loop or fiber resonator or other structure, where the beam and/or its derivatives travels a certain path, which length can be changed) determines the comb mode spacing Thus the choosing of the length of the resonator, such as the loop, offers easy, inexpensive and effective way to determine the comb mode spacing, and can be chosen according to an intended application of the comb. In addition in this case no mirrors are even needed, as the fiber loop forms the resonator. In contrast to microresonator combs known from prior art, the comb mode spacing according to the current invention can be designed for almost any application. Also small mode spacing of the order of 50 to 500 MHz can be easily obtained, unlike with the prior art Kerr combs, for example. The small mode spacing is needed, e.g. in gas analysis applications.

According to an embodiment the optical manipulator may also comprise at least one sample loop, such as an optical fiber resonator loop. The sample loop may receive the laser beam and/or its derivatives and introduce the received laser beam and/or its derivatives to interact with a sample medium, and thereby form an interacted laser beam derivative, comprising e.g. absorption spectrum. After interacting the sample loop advantageously introduces said interacted laser beam derivative back to the optical manipulator and to said component. The sample medium may be e.g. gas or liquid medium. The sample loop or apparatus may comprise a cavity, to which the sample medium can be led, for example, or portion of the covering material of the loop can be removed in order to arrange the sample medium to be optically contact with the portion of the sample loop and thereby allowing the laser beam and/or its derivatives interact with the sample medium.

It is to be noted that the sample loop can be used for introducing the beam and/or its derivative to interact with the sample medium, even if none of the first loop is used so the use of the first loop is not mandatory. In addition it is to be noted that the structure and properties of the sample loop are advantageously similar than with the first loop, but the sample loop is only modified so that it is able to introduce the beam and/or its derivative to interact with the sample medium.

Spectroscopy of a gas or liquid medium can be done inside or outside of the apparatus. The spectroscopy may be implemented by using e.g. two slightly different combs. The combs may be produced simultaneously by the apparatus thanks to the sample loop or a second first loop. According to an example the length of the sample loop is different than the length of any of the first loop, but may also be same.

According to an embodiment the component may comprise at least two portions, wherein the first portion comprises different structural properties than the second portion. The structural properties relate especially to the property of the second order nonlinearity or phase matching (or both), such as which wavelengths are phase matched and how much phase matching is deviated from zero. By this the first portion is configured to generate the frequency comb with frequencies differing from the frequency comb generated by the second portion, whereupon two different frequency combs can be formed.

Still in addition, the apparatus may also comprise an additional optical devices arranged in connection with the apparatus, such as an optical amplifier configured to amplify the intensity of at least one wavelength transferred by at least one loop or other portion of the apparatus. Alternatively or additionally the apparatus may also comprise an optical filter for filtering desired wavelengths, or amplitude or phase modulator, such as electro-optic modulator for modulating desired wavelengths, as an example.

As discussed elsewhere in this document, the comb mode spacing may be easily changed or controlled by changing the length of the resonator (such as a fiber loop or dimensions of other structure used as a resonator or part of a resonator, for example). Alternatively, or additionally also an electro-optic modulator can be used, at least for fine control of the mode spacing. The length of the resonator can be changed e.g. by mechanical stretching or thermal expansion. In addition the comb mode spacing can be changed or controlled by applying an electric field over the component and thereby changing the refractive index of said component.

As an example, the apparatus can be designed according to an embodiment so that it nominally produces a mode spacing of 100 MHz, for example, when a fine tuning of ˜1 MHz can be achieved e.g. by slightly changing the length of the resonator (such as a fiber loop). It should be noted that these values or ranges are only example and the invention or the scope of the invention is not limited only to those.

The apparatus advantageously comprises also an input for receiving and inputting the laser beam from a laser source, and additionally also an output for outputting the generated frequency comb, as well as other derivatives of the laser beams, such as the absorption spectrum, when one or more sample loops (or other portion of the resonator) are used for sample medium analysis or gathering optically data of the sample medium. The input and/or output may comprise an aperture, an optical fibre, optical waveguide, prism and/or lens, which can be used for guiding the laser beam in and out from the optical manipulator.

One of the basic principles of the method and apparatus for the frequency comb generation is following. At first the inputted laser beam is converted to a second harmonic (SH) wave, and after a short propagation in the component the second harmonic wave (SH) is back-converted to a new beam, which advantageously deviates slightly from the laser beam frequency due to the cascaded quadratic nonlinearity or additionally due to the phase matching deviated (slightly) from zero. It is to be noted that the SH is here only as an example and additionally also other cascaded quadratic nonlinear processes of type “second order nonlinearity” are possible, such as for example a sum frequency generation (SFG), so SFG with back conversion in analogous way as SHG with back conversion depicted above.

To be precise, the comb formation requires that new wavelength components are generated by this back-conversion process. These new components are advantageously in the same wavelength region as the inputted laser beam, but at slightly different wavelengths. Thus effects of the frequency comb essentially similar to those arising from true third-order nonlinearity can be achieved (mimicked).

A nonlinear refractive index n₂^{case} of the component used can be approximated as:

$${n}_{2}^{casc} = - \frac{1}{Δ k} \frac{4 π {d}_{eff}^{2}}{{n}_{pump}^{2} {n}_{SHG} {λ}_{pump} {ɛ}_{0} c} ,$$

where d_{eff} is the second-order nonlinear coefficient of the component material, and nₚᵤₘₚ and n_{shg} are the linear refractive indexes at the laser beam and second-harmonic frequencies, respectively, and Δk is a wave-vector mismatch representing said phase matching of the SH process.

According to an advantageous embodiment the nonlinear refractive index n₂^{case} is configured to be changeable by changing the value of wave-vector mismatch (Δk). As an example this can be done, e.g. by changing the poling period A of a quasi phase matching component (crystal). Another way to change the wave-vector mismatch (Δk) is via changing temperature of the component (crystal). Therefore, according to the invention, the nonlinear refractive index n₂^{case} can be positive or negative value (negative values of n₂^{case} can be obtained e.g. by using Δk>0). This is impossible with the prior art “true” Kerr nonlinearity, for which n₂ is always positive and depends on the material. This makes it possible to achieve not only positive but also negative SPM, which allows for compensation of both normal and anomalous dispersion, while the SPM arising from the “true” Kerr nonlinearity can only compensate for anomalous dispersion.

According to an embodiment the component (such as the crystal or the optical fiber) may consist of at least two different medium or the component (such as the crystal or the optical fiber) or at least part of it may be doped material. The doping may be implemented by a material that provides laser gain. In that case the component may interact with the laser beam inputted and generate a second wavelength of the inputted beam inside the resonator or optical manipulator. The second wavelength may function as the derivative, and serve as a pump to the cascade nonlinear process, and thereby generate the actual frequencies for the frequency comb.

It is to be noted that the apparatus may comprises a laser source, such as a continuous wave or pulsed pump laser source. Alternative or in addition to, an outer laser source may also be used, whereupon the optical manipulator is optically coupled, for example via the input, with the laser source output so that the laser beam can be introduced to the component as depicted. In addition it is to be noted that the offset frequency of the comb generated or shifted e.g. by portion 1 can be tuned by tuning the frequency or power of the used laser, such as a pump laser.

Further the embodiments of the invention described in this document, where at least one first loop and/or at least one sample loop are used, can be utilized in determining and analysing sample medium, such as gas or liquid samples. There the first frequency comb is advantageously generated by using at least the one first loop, as is depicted elsewhere in this document. However, according to another embodiment the first frequency comb may be generated just by using the component, whereupon the sample loop can be used even without the first loop or other resonator. Additionally at least one second loop is used to receive the laser beam and/or it derivatives, introduce the received laser beam and/or its derivatives to interact with a sample medium, and to form an interacted laser beam derivative comprising an absorption spectrum due do interaction with said sample. In addition interacted laser beam derivative is introduced back to the optical manipulator and again to the component to form a second frequency comb, the frequencies of which deviates from the first frequency comb by Δf.

According to an embodiment the apparatus may also comprise a detector, whereupon the first and second frequency combs are introduced to the detector. On the detector they form a third frequency comb, which is based on a beat signal of said first and second frequency combs on the detector. The beat signal is based on the (small) frequency differences Δf of said first and second frequency combs. According to an embodiment the comb mode spacing of the third frequency comb is Δf. Advantageously the third frequency comb comprises also the absorption spectrum information inherited from said second frequency comb. Most advantageously the frequency range or the comb mode spacing of said third frequency comb 4f is on the range of 1 Hz-1 kHz, in which case the third frequency comb is typically centered at 1 kHz-1 GHz (audio or radio frequencies), which are much easier to measure and analyse accurately than optical frequencies.

The present invention offers clear advantages over the known prior art, which are next discussed. In the current invention it is very convenient that the effective third order nonlinearity arising from the cascaded quadratic nonlinearity of the discussed embodiment can be tailored by adjusting Δk, while the prior art “true” Kerr nonlinearity is a fixed material parameter and cannot be changed. As a result the effective third order nonlinearity (i.e., the value of n₂) due to the cascaded quadratic nonlinearity (CQN) can be several orders of magnitude higher according to the current invention than the prior art “true” Kerr nonlinearity of most materials. Therefore, the laser intensity required for optical frequency comb (OFC) generation is significantly smaller in the current invention than in the case of prior art Kerr comb generation. In practice, this means more versatility in the implementation and application of the OFC.

While the prior art Kerr comb generation is only possible in microresonators, the frequency comb according to the invention can be generated in a larger resonator, which allows smaller mode spacing. In addition it does not need to be of that high quality even, which makes simpler implementation and possibility of obtaining a small mode spacing. The small mode spacing is needed e.g. in gas analysis.

In addition to the strength of effective four-wave mixing (FWM), as well as also other effects related to effective prior art Kerr nonlinearity, can be tailored e.g. by adjusting Δk. In particular, self-phase modulation (SPM) and cross-phase modulation (XPM) can be tailored according to the invention to balance resonator dispersion practically at any wavelength within the transparency range of the component, or crystal material. In the prior art “true” Kerr nonlinearity case, SPM and XPM are fixed material parameters, which makes the comb formation possible only at certain wavelengths, depending on material dispersion, which is clear disadvantage. This is one of the reasons why the prior art Kerr comb generation is difficult at mid-infrared wavelengths.

In addition the frequency comb generation according to the invention can be implemented e.g. with a simple continuous-wave (CW) laser without modulators, whereupon the apparatus is simple and inexpensive compared to e.g. mode-locked lasers. It is also possible to operate at any wavelength within the transparency range of the nonlinear crystal material. In particular, the frequency comb according to the invention also works in the mid-infrared region, so especially at wavelengths>3 μm, which is important for example for gas analysis applications, and cannot be accessed by mode-locked lasers. For example the mid-infrared operations with the prior art Kerr combs are challenging e.g. due to material dispersion.

Furthermore the frequency comb can be easily combined with other second-order nonlinear processes, which makes it possible to access e.g. the mid-infrared region with readily available low-cost near-infrared pump lasers, which is not possible with the prior art microresonator Kerr comb systems. Moreover, due to the high effective third-order nonlinearity, smaller laser intensity can be used than in the prior art Kerr combs. For the same reason, the resonator does not need to be of high quality. Together with the possibility to tailor the cascaded quadratic nonlinearity process, these features make versatile low-cost comb generation for a variety of applications possible. Also, the new embodiments based on an optical waveguide or microresonator make the comb generator compact and robust and lead to much higher laser intensity (and hence CQN strength) than in the “free-space” solutions presented. This is because the laser beams involved in the process are confined within a small mode volume by the waveguide/microresonator, while in the free-space solution the beams diverge as they propagate in the crystal.

The invention is explained in this document with reference to the aforementioned embodiments, and several advantages of the invention are demonstrated. It is clear that the invention is not only restricted to these embodiments, but comprises all possible embodiments within the spirit and scope of the inventive thought and the following patent claims. The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF THE DRAWINGS

Next the invention will be described in greater detail with reference to exemplary embodiments in accordance with the accompanying drawings, in which:

FIG. 1 illustrates, in time and frequency domains, a prior art optical frequency comb generation based on a mode-locked laser,

FIG. 2 illustrates the principle of the prior art microresonator Kerr comb generation,

FIG. 3 illustrates a principle of phase matching and mismatching,

FIG. 4 illustrates a principle of self-phase modulation originating from a cascaded quadratic process,

FIGS. 5A-5C illustrate principle of optical frequency comb generation by cascaded quadratic nonlinearity process according to an advantageous embodiment of the invention,

FIGS. 6A-6D illustrate examples of a cascaded quadratic nonlinearity (CQN) comb generation in a singly-resonant OPO advantageous embodiment of the invention,

FIGS. 7A-B illustrate a principle of an implementation of an optical frequency comb generation based on cascaded quadratic nonlinearity according to an advantageous embodiment of the invention,

FIGS. 8-9 illustrate examples of a comb generation using a solid component based on an optical waveguide according to an advantageous embodiment of the invention,

FIG. 10 illustrates another example of the comb generation according to an advantageous embodiment of the invention,

FIG. 11 illustrates still another example of the comb generation according to an advantageous embodiment of the invention, and

FIGS. 12-13 illustrate still another example of the comb generation according to an advantageous embodiment of the invention.

### DETAILED DESCRIPTION

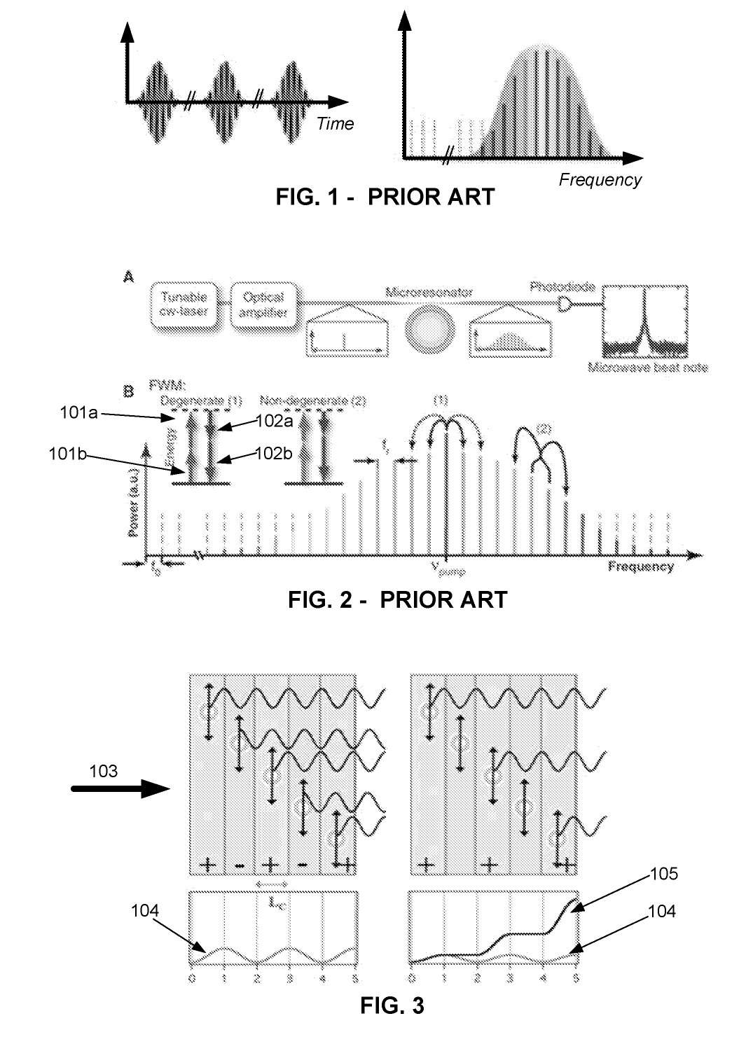

FIGS. 1-2 illustrate a prior art and are discussed earlier in this document.

FIG. 3 illustrates a principle of second harmonic generation without quasi-phase matching (left panel) and with quasi-phase mismatching (right panel). The second harmonic generation (SHG), or frequency doubling, is a typical example of a second order nonlinear process. In SHG, a laser beam (pump laser beam, a.k.a. fundamental beam, whose frequency is νₚᵤₘₚ=c/λₚᵤₘₚ, where λₚᵤₘₚ is the laser wavelength) 103 is passed through a nonlinear crystal. In this process, two pump photons are converted into a photon that has twice the energy of a pump photon. The pump laser beam can be efficiently converted into the second harmonic frequency (ν_{SHG}=2νₚ) if the following conditions are met:

Energy conservation:

hν_{SHG}=hνₚᵤₘₚ+hνₚᵤₘₚ (1)

Phase matching (momentum conservation):

Δk=k_{SHG}−2kₚᵤₘₚ=0 (2)

where kₓ=2πnₓ/λₓ is the wavevector, with x denoting the subscripts pump, SHG. The first of these conditions is met by definition. The phase matching condition, on the other hand, is in general not met because nₚᵤₘₚ≠n_{SHG} owing to material dispersion. The physical interpretation of this is such that as the phase velocities (c/nₓ) of the two waves in the crystal are different, SHG waves generated at different locations in the crystal interfere destructively, and thus no significant output at SHG is generated (see the left panel of FIG. 3). The left panel illustrates the phase-mismatched situation (Δk≠0) SHG, where there is not significant output power at frequency ν_{SHG}. The right panel illustrates the phase-matched (Δk=0) SHG process, where the power at frequency ν_{SHG} grows monotonically at the expense of pump power as the pump laser beam propagates in the crystal.

One of the most common techniques of achieving phase matching is quasi phase matching (QPM), where the crystal orientation is periodically inverted such that the phase of the emitted SHG wave is inverted (shifted by 180 deg) after every L_{c}. Here, L_{c}=π/(k_{SHG}−2kₚᵤₘₚ) is the so-called coherence length, i.e. the propagation length in the crystal (so component) after which the SHG field would normally come out of phase relative to the previously emitted field (see the curve 104 in FIG. 3). In practice, QPM can be achieved by periodical poling of the crystal material using an electric field that permanently inverts the crystal polarity. The poling period (QPM period), which is denoted by A, is typically 5-50 μm, depending on the crystal material, wavelengths, and on the type of interaction. In case of QPM, the phase-matching condition for SHG becomes:

Δk=k_{SHG}−2kₚᵤₘₚ−2π/Λ=0 (3)

If the crystal is patterned with a poling period Λ=L_{c}, then Δk=0 and (quasi) phase matching for efficient SHG is achieved. In this case, the SHG power grows monotonously as the pump laser beam propagates in the crystal (see the curve 105 in FIG. 3). Note, however, that the crystal can also be designed for other values of Λ, which makes it possible to tailor the value of phase-mismatch, Δk.

The cascaded quadratic nonlinearity is obtained especially if Δk is slightly detuned from zero. In this case, the pump field is first converted to the second harmonic (SH) wave, but after a short propagation in the crystal the SH-wave is back-converted to the pump frequency due to the phase mismatch (see FIG. 3). The term cascaded here refers to the fact that this process is a cascade of two second order nonlinear processes: SHG and back conversion. The back conversion process is also referred to as downconversion (as the frequency is halved), or optical parametric conversion. This kind of cascaded process results in physical phenomena, that essentially mimic those originating from the third order (the prior art Kerr nonlinearity). This can be described in terms of effective nonlinear refractive index, which is defined as:

$${n}_{2}^{casc} = - \frac{1}{Δ k} \frac{4 π {d}_{eff}^{2}}{{n}_{pump}^{2} {n}_{SHG} {λ}_{pump} {ɛ}_{0} c} \qquad ( 4 )$$

where d_{eff} is the second-order nonlinear coefficient of the crystal material, and nₚᵤₘₚ and n_{shg} are the linear refractive indexes at the pump and second-harmonic frequencies, respectively.

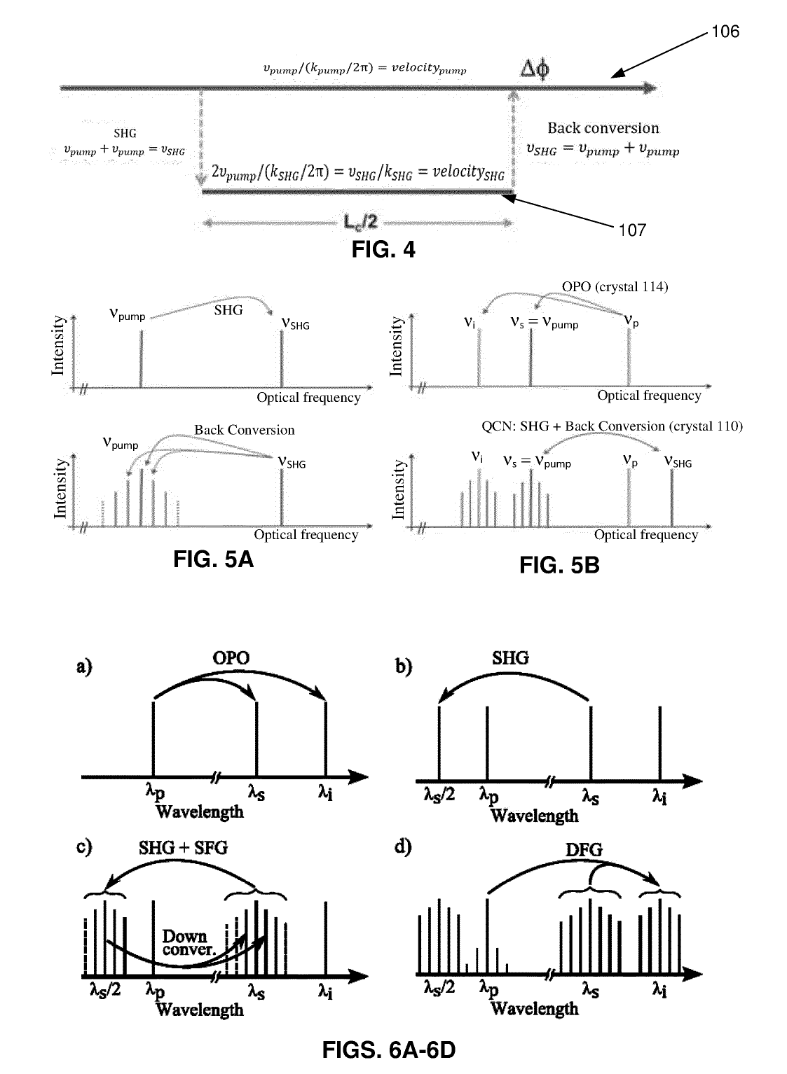

The cascaded quadratic nonlinearity can produce effects similar to those arising from the prior art “true” third-order nonlinearity. As an example, self-phase modulation arising from cascaded quadratic nonlinearity can be understood as shown in FIG. 4, which illustrates a principle of self-phase modulation originating from a cascaded quadratic process, where self-phase modulation is followed by back-conversion. The line 106 describes the fundamental (pump) field, and the 107 line denotes the field at SH frequency. Owing to phase-mismatch (Δk≠0), the generated SH wave is converted back to the fundamental frequency after a propagation of approximately half a coherence length. Because the pump wave and second harmonic wave propagate with different velocities in the crystal (so component), the back-converted wave acquires a phase difference Δϕ relative to the original pump field. As a result, also the total field (original+regenerated) at νₚᵤₘₚ is phase-shifted. This corresponds to the prior art “true” self-phase modulation.

FIGS. 5A, 5B illustrate principle of optical frequency comb generation by cascaded quadratic nonlinearity process according to an advantageous embodiment of the invention, where it can be seen that owing to the capability of cascaded quadratic nonlinearity to “mimic” third-order nonlinearities, such as FWM and SPM, optical frequency comb generation with effects similar to Kerr comb generation may be possible. The process is pumped with a laser at frequency νₚᵤₘₚ. Phase-mismatched second harmonic generation (SHG) produces light at frequency ν_{shg}. Back-conversion of this light generates a comb around νₚᵤₘₚ.

It's worth mentioning that the growth of comb side modes in the case of cascaded quadratic nonlinearity can also be explained by pure second-order processes, without analogy with Kerr-type four-wave mixing. Even in the case of small phase-mismatch (Δk≠0 but close to zero), there is always some second-harmonic (SH) power produced in the crystal (so crystal component). Therefore, for Δk=0 or for Δk≠0 but close to zero, this SH power can act as a pump for so-called optical parametric oscillation (OPO). This is a second-order nonlinear process essentially inverse to SHG but enhanced by an optical resonator. The original pump at frequency νₚᵤₘₚ needs to resonate in order this OPO/back-conversion process to take place. The optical bandwidth of the OPO process is relatively large, allowing for back-conversion to frequencies close to, but other than νₚᵤₘₚ exactly. In this manner, this cascaded process, SHG followed by back-conversion, transfers energy from the pump frequency to the nearby resonator modes, creating a frequency comb that has a mode spacing which is (approximately) equal to the resonator mode spacing. Also the OPO/back-conversion process needs to obey the phase-matching condition, but just like in the case of SHG, Δk doesn't need to be exactly zero. These both processes however become weaker as Δk is detuned away from zero.

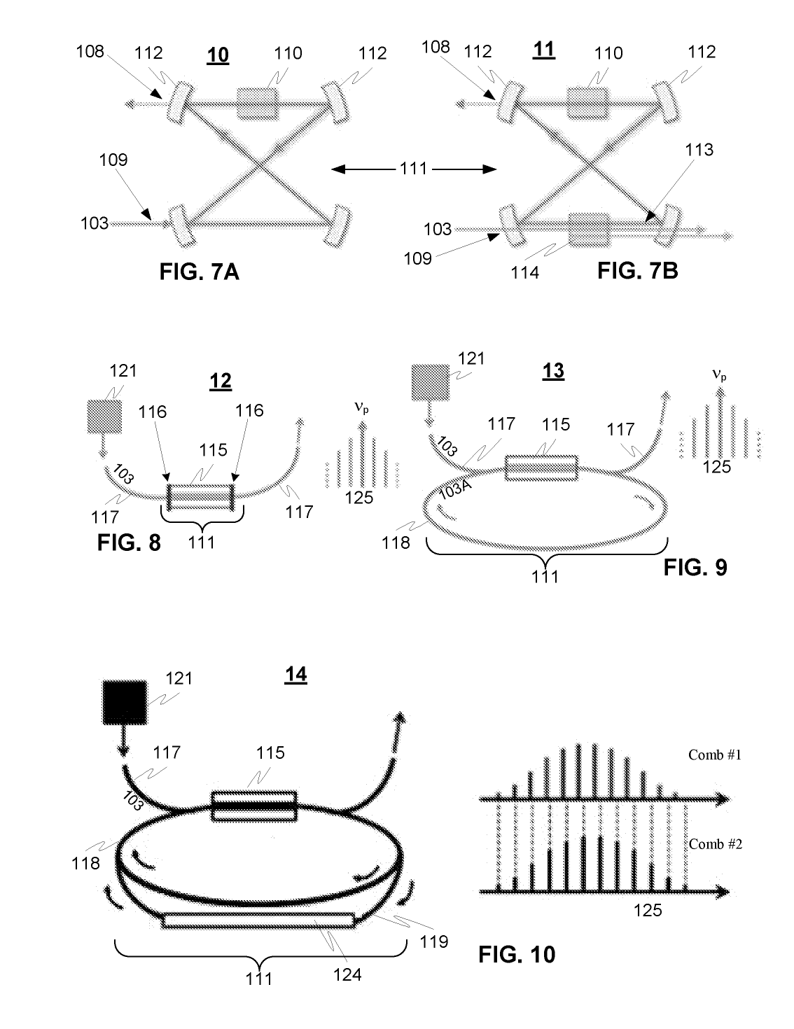

FIG. 6 illustrates a basic principle of optical frequency comb generation by the cascaded quadratic nonlinearity using the apparatus with an additional second-order nonlinear crystal component 114 presented in FIG. 7b. The upper panel of FIG. 5B shows the OPO process that takes place in the additional nonlinear crystal component 114. Either the “signal” beam or “idler” beam (or both) resonate in the optical manipulator (resonator) formed by the mirrors. The OFC is produced around the resonant wavelength (in this example around νₛ), if the cascaded quadratic nonlinearity process in first crystal component 110 is designed accordingly. This process, shown in the lower panel of FIG. 5B is identical to that shown in FIG. 5A. Due to other nonlinear mixing processes, the comb structure is copied also to other wavelengths involved, such as the idler.

In addition it is to be noted that the frequency comb structure is inherited around all derivatives owing to inherent nonlinear mixing processes. For example, the comb around the second harmonic (SH) frequency is produced by SHG and sum-frequency generation (SFG) from the comb modes that are located around the original pump laser frequency (νₚᵤₘₚ). Also, in the case of FIG. 6, SFG between the idler and signal waves copies the comb around frequency νₚ. as can be seen in FIG. 6A-6D.

FIGS. 6A-6D illustrates additionally cascaded quadratic nonlinearity (CQN) comb generation in a singly-resonant OPO. In FIG. 6A Signal and idler photons are generated from the pump photons (1/λₚ=1/λₛ+1/λᵢ, where λₚ, λs, and λi are the wavelengths of the pump, signal, and idler beams, respectively. The signal wave resonates in the OPO cavity. In Figs. B) and C), cascaded quadratic nonlinearities lead to comb formation (SFG=sum frequency generation). In Fig D) the comb structure is transferred to the idler wave by difference frequency generation (DFG). Back conversion of the signal and idler combs also creates a weak comb structure in the depleted pump wave.

FIGS. 7A-7B illustrate a principle of an implementation of an optical frequency comb generation based on cascaded quadratic nonlinearity according to an advantageous embodiment of the invention. The components of the cascaded quadratic nonlinearity based frequency comb generator apparatus 10, 11 illustrated in FIGS. 7A-7B are an input 109 for a laser beam that supplies energy for the cascaded quadratic nonlinearity process at frequency νₚᵤₘₚ, the second-order nonlinear crystal component 110 that produces the cascaded quadratic nonlinearity process, and the optical manipulator 111 (a.k.a. optical cavity) functioning as the resonator and formed by mirrors 112 or other reflecting devices. In addition the apparatus also comprises an output 108 for outputting the generated frequency comb. The pump wave resonates in the resonator, and the comb mode spacing is roughly determined by the resonator mode spacing. Also, the resonator is used for the efficient back-conversion process (OPO) to take place (FIG. 5A).

FIG. 7A illustrates an exemplary implementation (apparatus 10) of an optical frequency comb based on cascaded quadratic nonlinearity. The cascaded quadratic nonlinearity crystal component 110 is placed inside an optical manipulator 111 (functioning as a resonator) comprising four mirrors 112. Any number of mirrors is possible so to provide the resonator. FIG. 7B illustrates another exemplary implementation (apparatus 11), where the cascaded quadratic nonlinearity pump laser beam 113 is produced inside the manipulator 111 using another nonlinear process, namely optical parametric oscillation (OPO).

The apparatus 11 illustrated in FIG. 7B is otherwise similar to that 10 shown in FIG. 7A, but an additional second-order nonlinear crystal component 114 is placed in the optical manipulator 111. This component 114 is used for optical parametric oscillation (OPO), which is fundamentally similar to the back-conversion process illustrated in FIG. 5A. However, these two shouldn't be confused, namely there are also some differences. According to an embodiment the additional OPO is phase-matched such that a pump laser beam at frequency νₚ produces two new beams: so-called signal (νₛ, which now equals to νₚᵤₘₚ of the cascaded quadratic nonlinearity process) and idler (νᵢ), see FIG. 5B. As usual, energy is conserved in the process: νₚ=νₛ+νᵢ. The purpose of this additional process is two-fold:
(1) The pump beam (νₚᵤₘₚ) for the cascaded quadratic nonlinearity process is now produced inside the optical manipulator (resonator), in the additional crystal component 114. This simplifies the experimental implementation, since coupling of a high-power external pump beam to the resonator, as in the right panel of FIG. 7, is not always so trivial.
(2) The additional OPO works as a wavelength converter. Good and inexpensive pump lasers are readily available at near-infrared, but not at mid-infrared, which is an important wavelength range for many applications. The OPO converts light of the pump laser to the signal and idler frequencies, the latter of which typically lies in the mid-infrared region. In addition the optical frequency comb structure generated by cascaded quadratic nonlinearity around the signal frequency (νₛ) is inherently transferred to the mid-infrared region, around νᵢ. This occurs due to another second-order process, difference frequency generation (DFG), in the additional crystal component 114. The DFG process obeys the same phase-matching condition as the OPO process νₚ=νₛ+νᵢ and the comb at νₛ mixes with νₚ, producing a comb at νᵢ.

A common feature of the implementations illustrated in FIGS. 7A-7B is that they are based on a free-space optical manipulator 111 (resonator), where the resonator comprises separate mirrors 112, and the laser beam(s) propagate in free space between the mirrors. The apparatuses of FIGS. 7A, 7B and 8-9 may also comprise a laser source 121, but also auxiliary laser sources may be used. FIGS. 8-9 illustrate another examples (apparatus 12, 13) of a comb generation using a monolithic or other solid component based on an optical waveguide 115 according to an advantageous embodiment of the invention, where the resonator is formed around the second-order nonlinear material without any free-space propagation. The monolithic or other solid structure used in the apparatuses 12, 13 of FIGS. 8-9 makes the setup more compact, robust, as well as simpler and easier to use and assemble. Also, many embodiments of the monolithic or other solid structure lead to a higher laser intensity I_{L} inside the resonator (optical manipulator), which enhances the cascaded quadratic nonlinearity effect, hence making the comb generation possible with low-power lasers, allowing thus cost efficiency and low power consumption.

The waveguide 115 is advantageously fabricated inside an optical nonlinear crystal component material, which is for example periodically poled lithium niobate (PPLN). In apparatus 12 in FIG. 8, the resonator is formed by coating the crystal component ends with reflecting material 116 such that they 116 reflect the light at comb wavelength. Another possibility is to place mirrors in contact with the waveguide ends. Light is typically coupled in and out either in free space, or using optical fibers 117, but also other guiding devices can be used, as is described in this document elsewhere. In apparatus 13 in FIG. 9, the waveguide 115 (crystal component) is part of a fiber-optic resonator. In this embodiment no mirrors are needed, as a fiber loop 118 forms a resonator, so introduces the beam derivatives 103A in a repetitive or resonating manner to the component 115. The length of the resonator (loop 118) determines the comb mode spacing, and can be chosen according to the intended application of the comb, as is described in this document elsewhere.

FIG. 10 illustrates another example (apparatus 14) of the comb generation according to an advantageous embodiment of the invention, where additional components 119, 124, such as the sample (auxiliary) optical loop 119 can be integrated in to the apparatus. The sample optical loop 119 can be used for example to sample medium analysis, as is described elsewhere in this document. Additionally, or alternatively, the additional components 119, 124 may comprise also optical amplifiers, gas cells, or filters or the like. Also, the resonator can have several parallel branches that can have different lengths. As a result, several combs with different mode spacings can be generated with a single apparatus, which offers clear advantages over the prior art solutions.

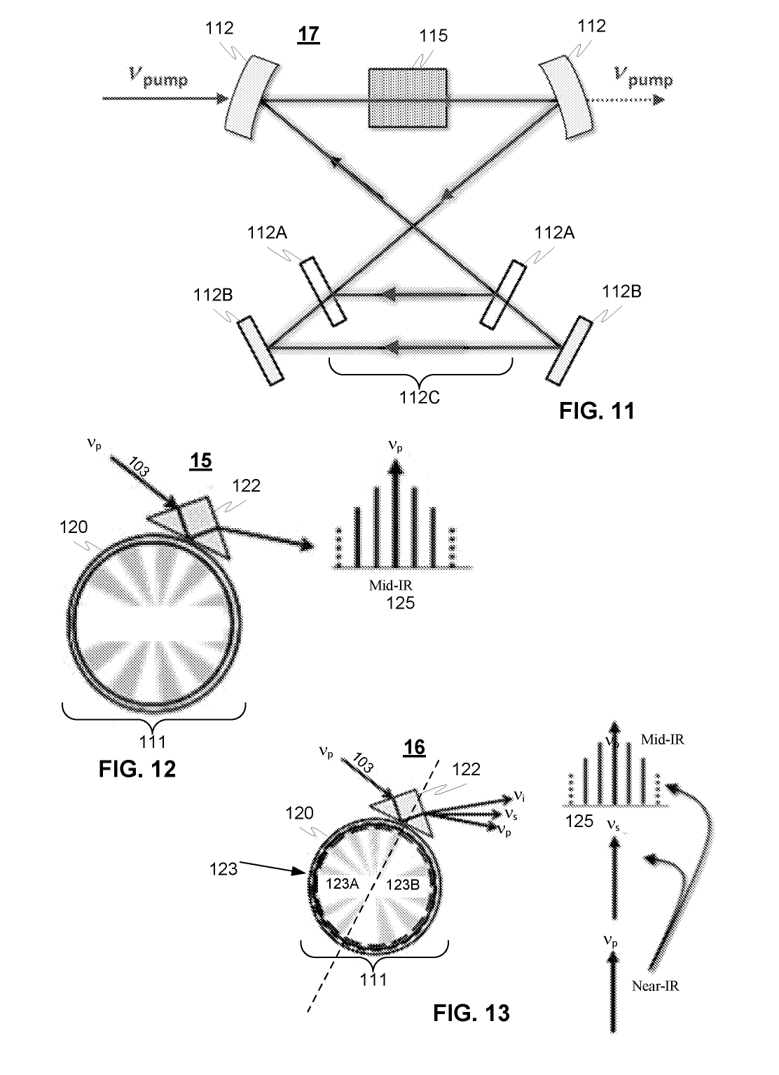

FIG. 11 illustrates still another example of the comb generation (apparatus 17) according to an advantageous embodiment of the invention, where the structure essentially similar as in FIG. 7A (or FIG. 7B) is modified by applying additional semi-transparent reflectors 112A between the original reflectors 112 and 112B, and thereby providing two parallel resonators with different lengths. According to an embodiment a sample to be determined may be inserted for example in the area of 112C, if this example is used for sample analysis (optional feature).

FIGS. 12-13 illustrate still another example (apparatus 15, 16) of the comb generation according to an advantageous embodiment of the invention by using the monolithic or other solid structure. In FIG. 12 the comb is generated in a microresonator 120 fabricated of a nonlinear quasi-phase-matched optical crystal. The apparatus and method can also be used to transfer the frequency comb to a different wavelength region than the original pump laser wavelength. For example, a mid-infrared comb can be generated using a low-cost near-infrared pump laser, as is depicted in FIG. 13, where the process is the same as that described in FIG. 6, and can also be implemented, e.g., in the embodiments of FIGS. 8 and 9. The quasi phase matching (QPM) structure responsible for the OPO wavelength conversion can be integrated in the same device with the QPM-structure responsible for the cascaded quadratic nonlinearity process, which is impossible with the conventional prior art Kerr combs. This can be achieved with the invention by doping 123 the component material with suitable doping medium or using two differently configured sections in the second order nonlinear medium (123A, 123B) in the microresonator component 120.

1. An apparatus for frequency comb generation using an optical manipulator,
wherein the apparatus comprises:
an input for guiding a continuous wave pumped laser beam into the optical manipulator,
a component comprising second order nonlinearity, the optical manipulator being configured to introduce said continuous wave pumped laser beam and/or its derivatives in a resonating manner to said component, whereupon the component is configured to interact with said laser beam or derivatives of said laser beam and thereby generate frequencies for the frequency comb, and
an output configured to output frequencies of the frequency comb generated by said component,
wherein
said component comprises at least one first and second portions, wherein a phase matching of the first portion deviates from zero, whereupon the second portion is configured to generate the frequency comb with frequencies differing from said frequency comb generated by said first portion.

2. An apparatus of claim 1, wherein said component comprises quasi-phase-matched optical nonlinear crystal material, comprising periodically poled lithium niobate (PPLN), periodically poled lithium tantalite (PPLT), periodically poled potassium titanyl phosphate (PPKTP), lithium niobate doped with metal ions, or birefringently phase-matched nonlinear crystals.

3. An apparatus of claim 1, whereupon said component is configured to perform cascading quadratic nonlinearity process.

4. An apparatus of claim 1, wherein the phase matching of said component is arranged to deviate from zero.

5. An apparatus of claim 1, wherein the optical manipulator comprises an optical resonator, optical fiber resonator or microresonator or monolithic or other solid crystal resonator.

6. An apparatus of claim 1, wherein the optical manipulator comprises mirrors arranged around the component, whereupon said component functions as a waveguide, and said mirrors are configured to reflect the inputted laser beam or its derivatives in a repetitive manner to said component within said optical manipulator.

7. An apparatus of claim 1, wherein the ends of the component are provided with reflective material in order to reflect said laser beam wavelength or its derivatives in a repetitive manner within said component.

8. An apparatus of claim 1, wherein interface materials at the interface of the component and the surrounding medium are selected to perform a total internal reflection of the laser beam or its derivatives and/or the angle of the laser beam or its derivatives is arranged to be as a critical angle for total internal reflection so that said total internal reflection is configured to reintroduce said laser beam or its derivatives in a repetitive manner within said component functioning as a waveguide.

9. An apparatus of claim 1, wherein the optical manipulator comprises at least one first loop, which is configured to receive said laser beam or its derivatives and additionally configured to introduce said received laser beam or its derivatives back to said optical manipulator and to said component.

10. An apparatus of claim 9, wherein apparatus comprises at least two first loops (118), wherein the length of the second first loop is same or different than the length of the first loop in order to provide the same or a different comb mode spacing.

11. An apparatus of claim 1, wherein the optical manipulator comprises at least one sample loop or resonator, which is configured to receive said laser beam and/or it derivatives, introduce said received laser beam or its derivatives to interact with a sample medium and to form an interacted laser beam derivative, and additionally configured to introduce said interacted laser beam derivative back to said optical manipulator and to said component.

12. An apparatus of claim 11, wherein the length of the sample loop is different than the length of at least one first loop.

13. An apparatus of claim 9, wherein the apparatus comprises an optical amplifier, optical filter, or amplitude or phase modulator, such as electro-optic modulator, arranged in the connection with said optical manipulator or at least one loop.

14. An apparatus of claim 1, wherein the optical manipulator comprises an optical microresonator, wherein said component material is arranged to interact with said laser beam or derivatives of said laser beam and thereby generate frequencies for the frequency comb.

15. An apparatus of claim 9, wherein the apparatus is configured to change or control the comb mode spacing by changing the length of the loop, using an electro-optic modulator, changing the resonator length by mechanical stretching or thermal expansion, or applying an electric field over the component and thereby changing the refractive index of said component.

16. An apparatus of claim 1, wherein said component comprises at least two portions, wherein the first portion comprises different structural properties of said second order nonlinearity, whereupon the second portion is configured to generate the frequency comb with frequencies differing from said frequency comb generated by said first portion.

17. An apparatus of claim 1, wherein said input and/or output comprises an aperture, an optical fibre, optical waveguide, prism or lens for guiding a laser beam in and out from the optical manipulator.

18. An apparatus of claim 1, wherein said apparatus is first configured to convert the inputted laser beam to a second harmonic wave, and after a propagation in the component to back-convert said second harmonic wave to a new beam deviating from the laser beam frequency due to the cascaded quadratic nonlinearity in order to produce effects of the frequency comb essentially similar to those arising from true third-order nonlinearity.

19. An apparatus of claim 1, wherein the apparatus is configured to produce said frequency comb in the mid-infrared region.

20. An apparatus of claim 1, wherein the apparatus comprises a laser source, comprising a continuous wave or pulsed pump laser source.

21. An apparatus of claim 1, wherein the component comprises at least two different medium, comprising doping material, and is configured to interact with the laser beam inputted to said component and generate a second wavelength of said inputted beam, wherein said second wavelength is configured to function as said derivative or a pump wave and generate the frequencies for the frequency comb.

22. A method for frequency comb generation, wherein the method comprises:
introducing a continuous wave pumped laser beam or its derivatives to a component in a resonating manner, where said component comprises second order nonlinearity, where said component interacts with said continuous wave pumped laser beam or derivatives of said laser beam and thereby generates frequencies for the frequency comb, and
outputting frequencies of the frequency comb generated by said component,
wherein
said component comprises at least one first and second portions, wherein a phase matching of the first portion deviates from zero, whereupon the first portion generates the frequency comb with frequencies differing from said frequency comb generated by said second portion.

23. A method of claim 22, wherein said component performs cascading quadratic nonlinearity process.

24. A method of claim 22, wherein the phase matching of said component deviates from zero.
